(19) United States
(12) Patent Application Publication
(10) Pub. No.: US 2013/0301209 A1
(43) Pub. Date: Nov. 14, 2013

(54) PCI CARD SECURING MECHANISM

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventor: HAI-QING ZHOU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/863,898

(22) Filed: Apr. 16, 2013

(30) Foreign Application Priority Data
May 10, 2012 (CN) 201210143449.4

(51) Int. Cl. G06F 1/18

(52) U.S. Cl. CPC G06F 1/186
USPC 361/679.32

(57) ABSTRACT

A Peripheral Component Interconnection (PCI) card securing mechanism includes a fixing assembly and an operating assembly. The fixing assembly includes a sidewall defining a notch and a clasp, and a fixing plate attaching to a PCI card. The fixing plate includes a resisting portion, and a clasp portion engaging with the clasp. The operating assembly includes a rotary body including an elastic strip, and a cover fixed on the sidewall. The cover is received in the notch. The rotary body is rotatably received in the cover. The resisting portion is inserted into the cover, and the rotary body is rotated to move into the cover to allow the resisting portion to be clamped between the elastic strip and a peripheral wall of the cover. The rotary body is rotated to move out of the cover when removing the PCI card.

### BACKGROUND

1. Technical field

The disclosure generally relates to Peripheral Component Interconnection (PCI) card securing mechanisms.

2. Description of the Related Art

Many electronic devices include Peripheral Component Interconnection (PCI) cards. A main board of the electronic device can be connected to various extension elements, such as graphics card and sound card, through the PCI card to extend functions of the electronic device. However, the assembly process and disassembly process of the PCI card can be complicated.

Therefore, there is room for improvement within the art.

### BRIEF DESCRIPTION OF THE DRAWINGS

Many aspects of an exemplary PCI card securing mechanism can be better understood with reference to the following drawings. The components in the drawings are not necessarily drawn to scale, the emphasis instead being placed upon clearly illustrating the principles of the exemplary PCI card securing mechanism. Moreover, in the drawings, like reference numerals designate corresponding parts throughout the several views. Wherever possible, the same reference numbers are used throughout the drawings to refer to the same or like elements of an embodiment.

FIG. 1 is a schematic view of a PCI card securing mechanism and PCI cards according to an exemplary embodiment, during an assembly process.

FIG. 2 is similar to FIG. 1, but showing an assembled state.

FIG. 3 is an exploded view of the PCI card securing mechanism and PCI cards shown in FIGS. 1 and 2.

FIG. 4 is an assembled view of a rotary body of the PCI card securing mechanism shown in FIG. 3.

FIG. 5 is an exploded view of the rotary body shown in FIG. 4.

FIG. 6 is similar to FIG. 5, but shown from another angle.

FIG. 7 is a cross-sectional view along line VII-VII shown in FIG. 1.

FIG. 8 is a cross-sectional view along line VIII-VIII shown in FIG. 2.

### DETAILED DESCRIPTION

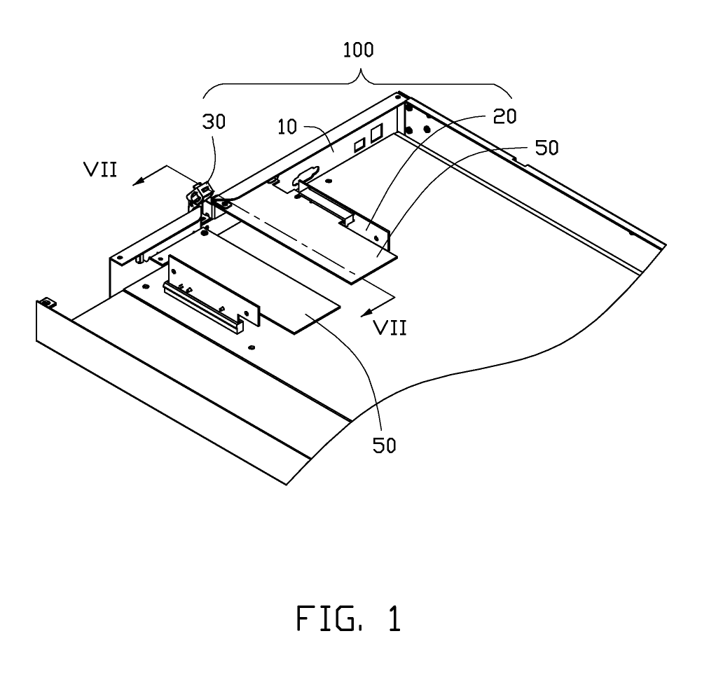

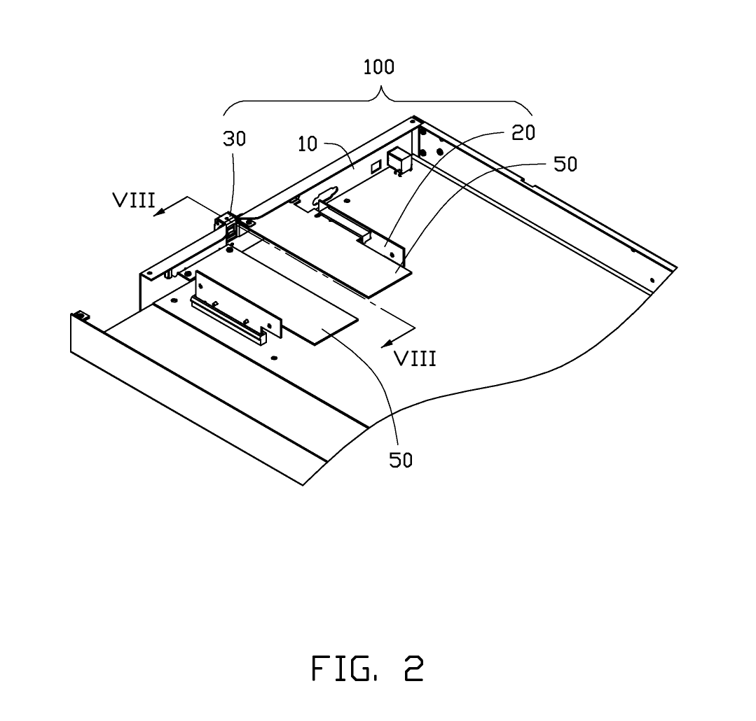

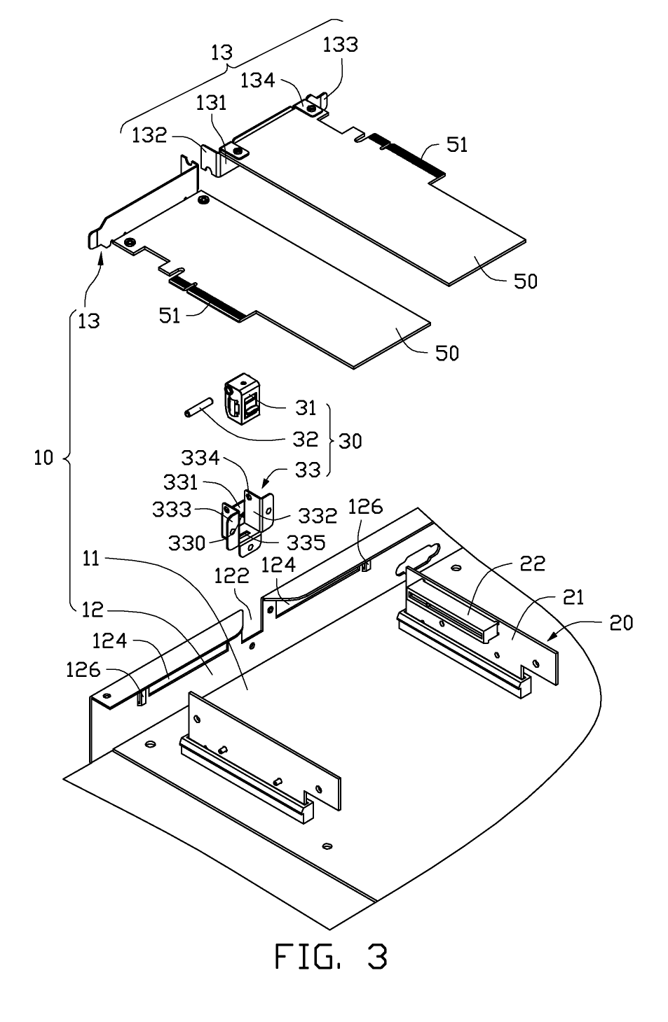

FIGS. 1-3 show a Peripheral Component Interconnection (PCI) card securing mechanism 100 for fixing PCI cards in electronic devices, such as computers and servers. The PCI card securing mechanism 100 includes a fixing assembly 10, a connection element 20, and an operating assembly 30. In the embodiment, two PCI cards 50 are removably mounted to an above-described electronic device through the fixing assembly 10 and the operating assembly 30. Each of the PCI cards 50 includes a plurality of terminals 51 and is electronically connected to the electronic device through the connection element 20.

The fixing assembly 10 includes a bottom plate 11, a sidewall 12, and two fixing plates 13. The sidewall 12 is perpendicularly connected to the bottom plate 11. Each fixing plate 13 is attached to one of the two PCI cards 50. In this embodiment, the bottom plate 11 and the sidewall 12 are parts of the electronic device.

The sidewall 12 defines a notch 122, two rectangular openings 124, and two clasps 126. The notch 122 is located between the two openings 124. Each opening 124 is located between the notch 122 and one of the two clasps 126.

Each fixing plate 13 includes a main body 131, a resisting portion 132, a clasp portion 133, and two opposite securing portions 134. The main body 131 is substantially planar, and the shape of the main body 131 corresponds to the shape of the opening 124. The size of the main body 131 is slightly larger than the size of the opening 124, and the main body 131 can be fixed in the opening 124. The resisting portion 132 is perpendicularly connected to an end of the main body 131. The clasp portion 133 furthest from the resisting portion 132 extends from the other end of the main body 131, and the clasp portion 133 is coplanar with the main body 131. The clasp portion 133 can be locked by a clasp 126, and the width of the clasp portion 133 is less than the width of the main body 131. The two securing portions 134 extending from a same side of the main body 131 are perpendicular to the main body 131 and the resisting portion 132. The two securing portions 134 are connected to a PCI card 50 corresponding to the fixing plate 13, through screws. The two securing portions 134 are parallel to the PCI card 50.

The connection element 20 includes two parallel adapter cards 21 for the two PCI cards 50. The two adapter cards 21 are perpendicularly connected to the bottom plate 11, and the two adapter cards 21 are electronically connected to internal circuits of the electronic device (not shown). Each adapter card 21 includes an interface 22, and the two interfaces 22 are opposite to each other.

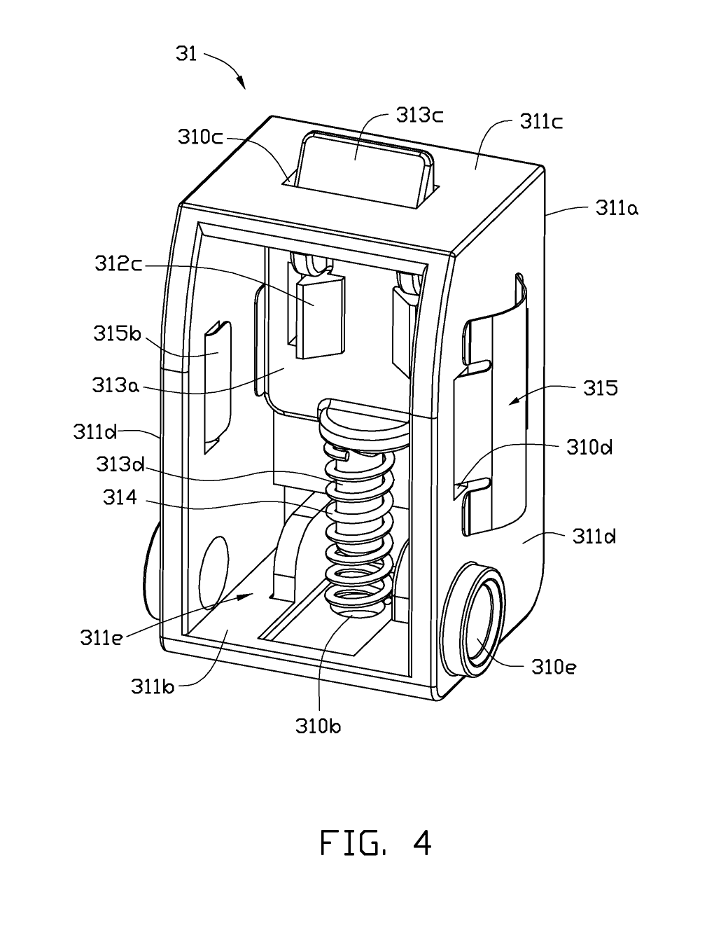

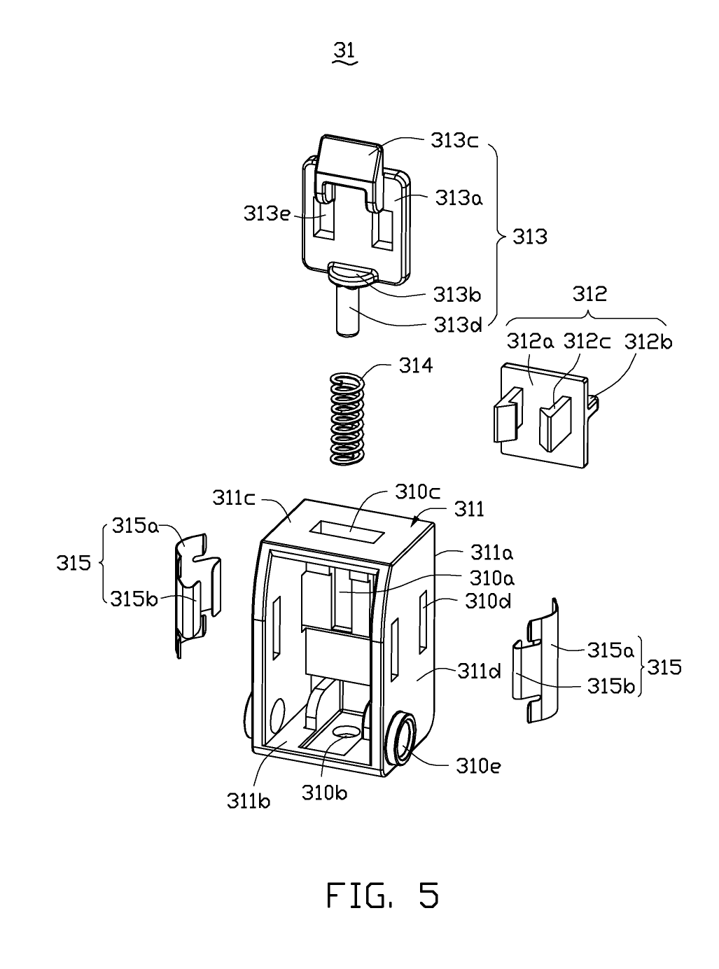

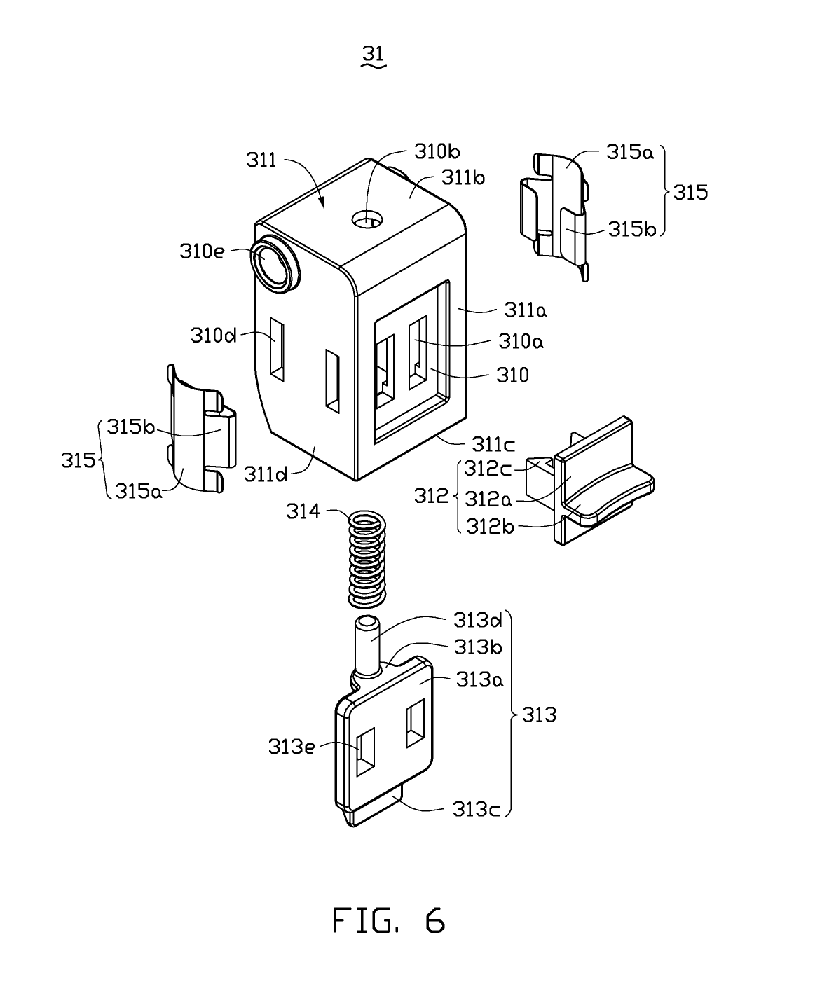

The operating assembly 30 includes a rotary body 31, a shaft 32, and a cover 33. Also referring to FIGS. 4-6, the rotary body 31 includes a housing 311, an operating element 312, a fixing element 313, an elastic element 314 and a pair of elastic strips 315. The housing 311 is substantially cubic and includes a first wall 311a, a second wall 311b, a third wall 311c, and two opposite fourth walls 311d. The second wall 311b, the third wall 311c, and the two fourth walls 311d are connected to flanges of the first wall 311a and are perpendicular to the first wall 311a. The second wall 311b is parallel to the third wall 311c, and the two fourth walls 311d are parallel to each other. Both the second wall 311b and the third wall 311c are perpendicularly connected to the two fourth walls 311d. The second wall 311b, the third wall 311c, and the two fourth walls 311d collectively enclose a cavity 311e. The first wall 311a defines a groove 310, and a bottom surface of the groove 310 defines two parallel sliding slots 310a. The second wall 311b defines a circular through hole 310b. The third wall 311c defines a slot 310c. Each fourth wall 311d defines two parallel latching holes 310d and an axle hole 310e.

The operating element 312 includes a sliding plate 312a, an operating portion 312b, and a pair of claws 312c. The length of the sliding plate 312a is shorter than the length of the groove 310, and the sliding plate 312a is slidably received in the groove 310. The operating portion 312b is a protrusion protruding from a surface of the sliding plate 312a. The pair of claws 312c is formed on another surface of the sliding plate 312a and each claw 312c is slidably received in a sliding slot 310a.

The fixing element 313 includes a plate 313a, a connection portion 313b, a fixing portion 313c, and a post 313d. The plate 313a is slidably received in the cavity 311e. The connection portion 313b is substantially a semi-circular plate, and is perpendicularly connected to an end of the plate 313a. The fixing portion 313c is substantially wedge-shaped, and extends from another end of the plate 313a. The post 313d is perpendicularly connected to the connection portion 313b. The diameter of the post 313d is less than the diameter of the through hole 310b. The plate 313a defines two locking holes 313e corresponding to the pair of claws 312c.

The elastic element 314 is a spring coiled around the post 313d. The elastic element 314 is longer than the post 313d.

The two elastic strips 315 can be made of metal or similarly resilient material. Each elastic strip 315 includes a base portion 315a and two hooks 315b. The base portion 315a is substantially a plate including a curved middle part. Two opposite sides of the base portion 315a respectively form a flange extending away from the base portion 315a, and each flange bends back to the base portion 315a to form the hook 315b. Each hook 315b engages with one of the latching holes 310d.

The shaft 32 is rotatably received in the two axle holes 310e. The cover 33 includes a base wall 331, three peripheral walls 332 and three engagement portions 333. The three peripheral walls 332 are perpendicularly connected to the base wall 331 and enclose a receiving space 330. Each engagement portion 333, parallel to the base wall 331, is perpendicularly connected to a free end of a peripheral wall 332. A shaft hole 334 is defined through two parallel peripheral walls 332. The peripheral wall 332 which is located between the two parallel peripheral walls 332 defines an aperture 335 for receiving a distal end of the fixing portion 313c.

The assembly process of the rotary body 31 is as follows:

One end of the elastic element 314 is attached to the connection portion 313b, and the other end of the elastic element 314 passes over a free end of the post 313d. Thus, the elastic element 314 is coiled around the post 313d. The fixing element 313 and the elastic element 314 are received in the cavity 311e, and the other end of the elastic element 314 at the free end of the post 313d is aligned with the through hole 310b and is fixed on the second wall 311b. The fixing element 313 moves in the housing 311 and compresses the elastic element 314 until the fixing portion 313c is aligned with the slot 310c. The elastic element 314 rebounds to engage the fixing portion 313c with the slot 310c, and the distal end of the fixing portion 313c is exposed out of the slot 310c.

The sliding plate 312a of the operating element 312 is received in the groove 310. The pair of claws 312c are passed through the two sliding slots 310a and the two locking holes 313e, and lock with the plate 313a of the fixing element 313. When the sliding plate 312a slides in the groove 310, the sliding plate 312a drives the fixing element 313 to slide along the sliding slots 310a. The two hooks 315b of each elastic strip 315 are engaged with the two parallel latching holes 310d of the fourth wall 311d corresponding to the elastic strip 315. A convex side of the base portion 315a is furthest from the fourth wall 311d.

The assembled rotary body 31 is received in the receiving space 330. The two axle holes 310e and the shaft holes 334 are aligned. The shaft 32 is rotatably received in the two axle holes 310e and ends of the shaft 32 are received in the shaft holes 334. Thereby, the rotary body 31 is rotatably received in the cover 33.

The cover 33 is located in the notch 122 of the sidewall 12. The three engagement portions 333 are secured on the sidewall 12 by screws. The assembly process of the PCI card securing mechanism 100 is thus completed.

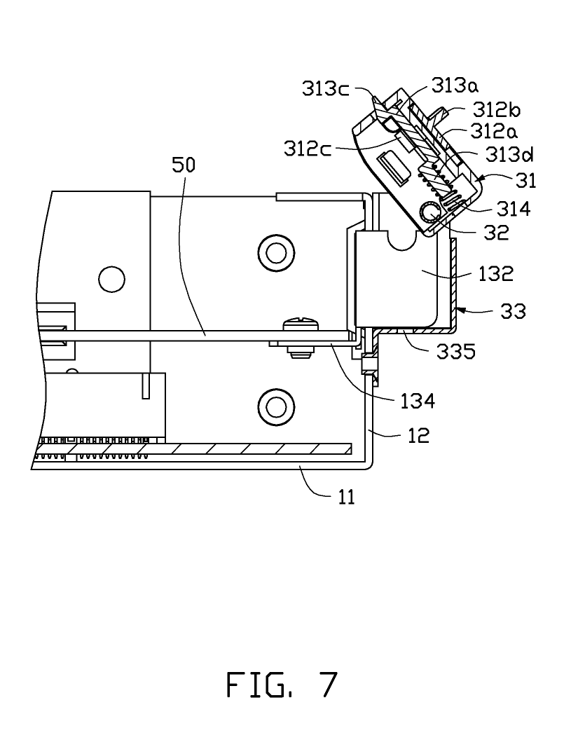

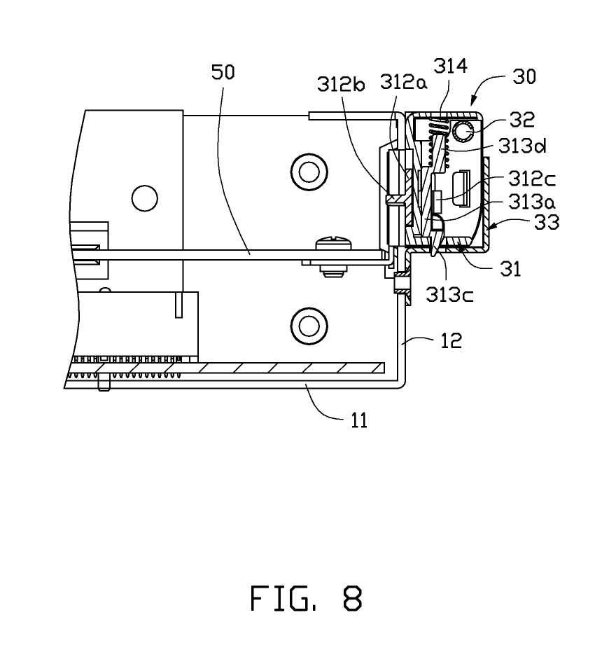

Referring to FIGS. 7-8, when assembling the PCI cards 50 to the electronic device, each PCI card 50 is placed parallel to the bottom plate 11, and is connected to the two securing portions 134 of a fixing plate 13. The rotary body 31 is rotated around the shaft 32 to move out of the cover 33. The resisting portion 132 of each fixing plate 13 is inserted into the cover 33. The clasp portion 133 of each fixing plate 13 is fixed by a clasp 126. The rotary body 31 is rotated around the shaft 32 to move into the cover 33, and the rotary body 31 is then located between the two resisting portions 132. The base portions 315a are resisted by the two resisting portions 132 and are elastically deformed. Each resisting portion 132 is clamped between a base portion 315a and a peripheral wall 332. The clasp portion 133 of each fixing plate 13 is more tightly fixed by the clasp 126 under elastic force of the base portion 315a. The distal end of the fixing portion 313c exposed out of the slot 310c is moved so as to align with the aperture 335 and is fixed in the aperture 335. Then, the rotary body 31 is secured to the cover 33. The terminals 51 of the PCI card 50 are electronically connected to the interface 22 of an adapter card 21.

If the PCI cards 50 need to be disassembled, the operating portion 312b of the operating element 312 is pushed to drive the sliding plate 312a to slide toward the second wall 311b. The pair of claws 312c in the two sliding slots 310a drive the fixing element 313 to slide toward the second wall 311b. The elastic element 314 is compressed by the fixing element 313. The fixing portion 313c is moved out of the aperture 335 and the slot 310c. The rotary body 31 is rotated around the shaft 32 to move out of the cover 33. The clasp portion 133 of each fixing plate 13 is released from the clasp 126. Then the PCI cards 50 can be taken away.

The PCI card securing mechanism 100 fixes the PCI cards 50 in the electronic device, and the PCI cards 50 can be assembled and disassembled by operating the operating assembly 30, without using or removing any screws. It is very easy to assemble or disassemble the PCI cards 50.

In another exemplary embodiment, the PCI card securing mechanism 100 only fixes one PCI card 50, and only one fixing plate 13 is needed.

In another exemplary embodiment, the two securing portions 134 are attached to the PCI card 50 by adhesive such as glue.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in the matters of shape, size, and arrangement of parts within the principles of exemplary disclosure to the full extent indicated by the broad general meaning of the terms in which the appended claims are expressed.

What is claimed is:

1. A Peripheral Component Interconnection (PCI) card securing mechanism for fixing a PCI card in an electronic device, the PCI card securing mechanism comprising:
a fixing assembly comprising a sidewall and a fixing plate attaching to the PCI card, the sidewall defining a notch and a clasp, the fixing plate comprising a resisting portion and a clasp portion engaging with the clasp; and
an operating assembly comprising a rotary body and a cover, the cover being fixed on the sidewall and being received in the notch, the rotary body being rotatably received in the cover and the rotary body comprising an elastic strip;
wherein the resisting portion of the fixing plate is inserted into the cover and the rotary body is rotated to move into the cover, the resisting portion is clamped between the elastic strip and a peripheral wall of the cover to assemble the PCI card; the rotary body is rotated to move out of the cover, the resisting portion is moved out of the cover and the clasp portion is released from the clasp to remove the PCI card.

2. The PCI card securing mechanism as claimed in claim 1, wherein the fixing plate further comprises a main body and a securing portion; the resisting portion is perpendicularly connected to an end of the main body; the clasp portion away from the resisting portion extends from another end of the main body, and the clasp portion is coplanar with the main body; the securing portion extending from the main body is perpendicular to the main body and the resisting portion, and the securing portion is connected to the PCI card.

3. The PCI card securing mechanism as claimed in claim 2, wherein the rotary body further comprises a housing, the housing comprises a first wall, a second wall, a third wall parallel to the second wall, and two opposite fourth walls; the second wall, the third wall, and the two fourth walls are respectively connected to flanges of the first wall and are perpendicular to the first wall; the second wall, the third wall, and the two fourth walls enclose a cavity together; the elastic strip is located on one of the two fourth walls.

4. The PCI card securing mechanism as claimed in claim 3, wherein the first wall defines a groove, and a bottom surface of the groove defines two parallel sliding slots; the rotary body further comprises an operating element, the operating element comprises a sliding plate, an operating portion protruding from a surface of the sliding plate, and a pair of claws forming on another surface of the sliding plate; the sliding plate is slidably received in the groove, and each claw is slidably received in one of the sliding slots.

5. The PCI card securing mechanism as claimed in claim 4, wherein the rotary body further comprises a fixing element, the fixing element comprises a plate slidably received in the cavity, a connection portion perpendicularly connected to an end of the plate, a fixing portion, and a post; the plate defines two locking holes corresponding to the pair of claws; the fixing portion extends from another end of the plate; the post is perpendicularly connected to the connection portion; the pair of claws are respectively passed through the two sliding slots and are respectively locked with the two locking holes.

6. The PCI card securing mechanism as claimed in claim 5, wherein the fixing portion is wedge-shaped.

7. The PCI card securing mechanism as claimed in claim 5, wherein the second wall defines a through hole, the post is aligned with the through hole, and diameter of the post is less than diameter of the through hole; the third wall defines a slot, the fixing portion is movably engaged with the slot, and a distal end of the fixing portion is exposed out of the slot.

8. The PCI card securing mechanism as claimed in claim 7, wherein the rotary body further comprises an elastic element, the elastic element is a cylindrical helical spring, and is coiled around the post; one end of the elastic element is attached to the connection portion, and the other end of the elastic element is fixed on the second wall.

9. The PCI card securing mechanism as claimed in claim 8, wherein the cover defines an aperture, and when the rotary body is rotated to move into the cover, the distal end of the fixing portion is moved to align with the aperture and is fixed in the aperture.

10. The PCI card securing mechanism as claimed in claim 9, wherein the operating assembly further comprises a shaft, the rotary body is rotatably received in the cover by the shaft.

11. A Peripheral Component Interconnection (PCI) card securing mechanism for fixing a PCI card in an electronic device, the PCI card securing mechanism comprising:
a fixing assembly comprising a sidewall and a fixing plate attaching to the PCI card, the sidewall defining a notch and a clasp, the fixing plate comprising a resisting portion, and a clasp portion engaging with the clasp;
an operating assembly comprising a rotary body and a cover, the cover being fixed on the sidewall and being received in the notch, the rotary body being rotatably received in the cover and the rotary body comprising an elastic strip; and
a connection element located on the fixing assembly, the PCI card being electronically connected to the electronic device through the connection element;
wherein the resisting portion of the fixing plate is inserted into the cover and the rotary body is rotated to move into the cover, the resisting portion is clamped between the elastic strip and a peripheral wall of the cover to assemble the PCI card; the rotary body is rotated to move out of the cover, the resisting portion is moved out of the cover and the clasp portion is released from the clasp to remove the PCI card.

12. The PCI card securing mechanism as claimed in claim 11, wherein the rotary body further comprises a housing, the housing comprises a first wall, a second wall, a third wall parallel to the second wall, and two opposite fourth walls; the second wall, the third wall, and the two fourth walls are respectively connected to flanges of the first wall and are perpendicular to the first wall; the second wall, the third wall, and the two fourth walls enclose a cavity together; the elastic strip is located on one of the two fourth walls.

13. The PCI card securing mechanism as claimed in claim 12, wherein the first wall defines a groove, and a bottom surface of the groove defines two parallel sliding slots; the rotary body further comprises an operating element, the operating element comprises a sliding plate, an operating portion protruding from a surface of the sliding plate, and a pair of claws forming on another surface of the sliding plate; the sliding plate is slidably received in the groove, and each claw is slidably received in one of the two sliding slots.

14. The PCI card securing mechanism as claimed in claim 13, wherein the rotary body further comprises a fixing element, the fixing element comprises a plate slidably received in the cavity, a connection portion perpendicularly connected to an end of the plate, a fixing portion, and a post; the plate defines two locking holes corresponding to the pair of claws; the fixing portion extends from another end of the plate; the post is perpendicularly connected to the connection portion; the pair of claws are respectively passed through the two sliding slots and are respectively locked with the two locking holes.

15. The PCI card securing mechanism as claimed in claim 14, wherein the fixing portion is wedge-shaped.

16. The PCI card securing mechanism as claimed in claim 14, wherein the second wall defines a through hole, the post is aligned with the through hole, and diameter of the post is less than diameter of the through hole; the third wall defines a slot, the fixing portion is movably engaged with the slot, and a distal end of the fixing portion is exposed out of the slot.

17. The PCI card securing mechanism as claimed in claim 16, wherein the rotary body further comprises an elastic element, the elastic element is a cylindrical helical spring, and is coiled around the post; one end of the elastic element is attached to the connection portion, and the other end of the elastic element is fixed on the second wall.

18. The PCI card securing mechanism as claimed in claim 17, wherein the cover defines an aperture, and when the rotary body is rotated to move into the cover, the distal end of the fixing portion is moved to align with the aperture and is fixed in the aperture.

19. The PCI card securing mechanism as claimed in claim 18, wherein the fixing plate further comprises a main body and a securing portion; the resisting portion is perpendicularly connected to an end of the main body; the clasp portion away from the resisting portion extends from another end of the main body, and the clasp portion is coplanar with the main body; the securing portion extending from the main body is perpendicular to the main body and the resisting portion, and the securing portion is connected to the PCI card.

20. The PCI card securing mechanism as claimed in claim 19, wherein the operating assembly further comprises a shaft, the rotary body is rotatably received in the cover by the shaft.
